(19) United States
(12) Patent Application Publication
(10) Pub. No.: US 2014/0080606 A1
(43) Pub. Date: Mar. 20, 2014

(54) METHODS AND SYSTEMS FOR GENERATING A SCENARIO OF A GAME ON THE BASIS OF A PIECE OF MUSIC

(71) Applicants: Olivier Gillet, Paris (FR); Sébastien Metrot, Paris (FR)

(72) Inventors: Olivier Gillet, Paris (FR); Sébastien Metrot, Paris (FR)

(21) Appl. No.: 13/142,330

(22) PCT Filed: Jun. 24, 2011
(86) PCT No.: PCT/US11/41821

§ 371 Date: Jun. 27, 2011

(30) Foreign Application Priority Data
Mar. 17, 2011 (FR) 11/52207

(51) Int. Cl. A63F 13/00

(52) U.S. Cl. CPC A63F 13/00
USPC 463/35

(57) ABSTRACT

Disclosed is a method for generating a game level as a function of musical parameters. These parameters comprise the rhythm, the recurrence of motifs, their tonality and the instrumental timbres. The disclosure also pertains to a game comprising means for implementing such a method. The disclosure allows the use of a piece of music which is chosen and/or provided by the player, and makes it possible to provide a game path which is consistent with the moods and the musical preferences of each player.

### CROSS REFERENCE TO RELATED APPLICATIONS

This claims priority from French application Ser. No. 11/52,207, filed on Mar. 17, 2011, entitled, “METHOD FOR GENERATING A SCENARIO ON THE BASIS OF A PIECE OF MUSIC, GAME AND SYSTEMS COMPRISING MEANS FOR IMPLEMENTING SUCH METHOD”, which is incorporated herein by reference.

### FIELD

The present disclosure relates to methods and systems for automatically developing elements of a video game on the basis of musical data external to the game, and in particular for developing a level of the video game based on an audio signal.

### BACKGROUND

Games driven by music are known in which certain events of the game, such as the appearance of enemies, the placement of obstacles to be circumvented, or the property of certain objects are synchronized with the score of a piece of background music. Customarily, the developers of games of this type employ skilled musicians to transcribe the music into events of the game. Thus, a piece of background music must be known well upstream in the development of the game, so that the player can have no choice other than from among the pieces of music that will have been previously transcribed by the developer. Furthermore, this requires the developer to pay expensive licenses for these pieces of music.

### SUMMARY

The present disclosure relates to developing elements of a video game based on externally derived musical data. Just like the events constituting the core of the game, other continuous variables of the game may be associated with the background music. The term level discussed herein, as it is commonly used, to designate an “episode” of a game comprising, in particular but not limited to, a setting and difficulty specification of the game. The term “continuous variable” should be understood in contradistinction to a variable whose changes are synchronous with a grid of musical events, such as, but not limited to time beats. These continuous variables, which are updated at a frequency which may reach the image refresh frequency may determine the color or the geometry of an element of the game or of the backdrop. For example, the developer may associate dramatic music with dark and/or cold colors, or a steeper slope with more powerful music, in a ski slalom game.

It would therefore be advantageous for such games to be able to use pieces of music provided or chosen by an end user, that is to say a player, instead of or as an alternative to a piece of background music provided by the developer. Thus, this allows the user to play a piece of music that suits him, and for which the user may have paid for the license, for example by purchasing the CD.

According to some embodiments, methods and system are disclosed for defining the course of a game as a function of a piece of music proposed by a user. The present disclosure discusses, according to some embodiments, a method for generating a level of a game on the basis of a raw audio signal. The method includes accessing (or providing) the raw audio signal. The method extracts audio attributes from the signal. The signal is then segmented into pulsations. The method then associates game events of the game with salient instants (or notes). Within the disclosure of this application, the terms salient instants and notes are interchangeable terminology. Furthermore, the method can extract continuous game variables, which are then utilized in development of the game level. According to some embodiments, the association of the events advantageously takes account of a difficulty constraint for the game.

According to some embodiments, the audio attributes preferably comprise at least one attribute from among a plurality of attributes. The attributes can include, but are not limited to: the sound loudness, preferably measured according to a psycho-acoustic model; timbre coefficients; chroma coefficients; spectral attributes; the dominant fundamental frequency; and temporal measurements of di-similarity with another instant. After having segmented the signal into pulsations, the pulsations are advantageously grouped into blocks of pulsations, the blocks being inter-compared and then clustered, in such a way that repeated sections of the music correspond to identical continuous variables or events.

According to embodiments, the events and the salient instants are associated by HMM decoding. According to some embodiments, the events and the salient instants are associated by patterns. A sequence of audio attributes can be matched with a corresponding library of predefined patterns.

In another embodiment, a computer-readable storage medium is disclosed for defining the course of a game as a function of a piece of music proposed by a user.

In yet another embodiment, a system is disclosed for defining the course of a game as a function of a piece of music proposed by a user. This system, which includes a remote server, includes an audio analyzer for determining the audio characteristics and storage means for these characteristics. The remote server also implements an automatic level generator for determining a game level on the basis of data descriptive of the game and means for storing the level.

These and other aspects and embodiments will be apparent to those of ordinary skill in the art by reference to the following detailed description and the accompanying drawings.

### BRIEF DESCRIPTION OF THE DRAWINGS

In the drawing figures, which are not to scale, and where like reference numerals indicate like elements throughout the several views:

FIG. 1 is a block diagram of a user computing device communicating with a server over a network in accordance with an embodiment of the present disclosure;

FIG. 2 illustrates a schematic for processing an audio signal in accordance with an embodiment of the present disclosure;

FIG. 3 illustrates a flow chart for processing an audio signal in accordance with an embodiment of the present disclosure;

FIG. 4 illustrates a flow chart for processing an audio signal in accordance with an embodiment of the present disclosure;

FIGS. 5A-5B illustrate a flow chart for processing an audio signal in accordance with an embodiment of the present disclosure;

FIG. 6 illustrates a flow chart for processing an audio signal in accordance with an embodiment of the present disclosure;

FIG. 7 illustrates a flow chart for processing an audio signal in accordance with an embodiment of the present disclosure;

FIG. 8 illustrates a block diagram for processing an audio signal in accordance with an embodiment of the present disclosure;

FIG. 9 illustrates a block diagram for processing an audio signal in accordance with an embodiment of the present disclosure;

FIG. 10 is a block diagram illustrating an internal architecture of a computing device in accordance with an embodiment of the present disclosure.

### DESCRIPTION OF EMBODIMENTS

Embodiments are now discussed in more detail referring to the drawings that accompany the present application. In the accompanying drawings, like and/or corresponding elements are referred to by like reference numbers.

Various embodiments are disclosed herein; however, it is to be understood that the disclosed embodiments are merely illustrative of the disclosure that can be embodied in various forms. In addition, each of the examples given in connection with the various embodiments is intended to be illustrative, and not restrictive. Further, the figures are not necessarily to scale, some features may be exaggerated to show details of particular components (and any size, material and similar details shown in the figures are intended to be illustrative and not restrictive). Therefore, specific structural and functional details disclosed herein are not to be interpreted as limiting, but merely as a representative basis for teaching one skilled in the art to variously employ the disclosed embodiments.

The present invention is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer, special purpose computer, ASIC, or other programmable data processing apparatus, such that the instructions, which execute via the processor of the computer or other programmable data processing apparatus, implement the functions/acts specified in the block diagrams or operational block or blocks.

In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved. Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

The principles described herein may be embodied in many different forms. The described systems and methods allow for automatic development of elements of a video game based on musical data. The musical data corresponds to data of an audio signal or file that is external to the game.

According to some exemplary embodiments, the audio signal is utilized to develop a level of the game. For example, a raw audio signal (such as an .mp3 file) is analyzed and extracted from it is a sequence of discrete and continuous values used to control the game-play of a music-driven video game. The analysis and extraction process is designed in such a way that it ensures, but not limited to: (1) synchronicity of the events with the rhythm of the music; (2) correlation between various aspects (harmony, timbre, among others) of the music content and the game-play; (3) consistency with the structure of the music, i.e., repeated sections in the music, such as the chorus or verses, are translated into similar game phases; (4) high level of control on the playability of the sequence, independently of the music: it must be possible to consistently achieve a target game difficulty level from a large variety of music genres and tempi; and (5) correlation between the visual aspect of the game and various aspects of the music content.

The first three (1-3) constraints ensure that the players can use their knowledge of the music to anticipate game actions. The fourth (4) constraint ensures that an enjoyable game-play, adapted to the player's skills, can be extracted independently of the genre and tempo of the music. The fifth (5) constraint is purely aesthetic and contributes to turn the game into a synthetic or choreographic experience.

For the purposes of this disclosure, a music-driven game is a game in which game events, such as the apparition of enemies to kill, the layout of the obstacles to clear, the properties of game objects (power and range of weapons, slope and orientation of terrain, etc.) are synchronized to the background music score. The present disclosure describes herein includes a chain of signal processing and statistical analysis operations to automate the level-generation for a music-driven game, and convert any music file into a unique video-game level.

A music-driven game is not specific to a particular category of game. Examples of a music-driven game are, but not limited to: Guitar hero-like games, Rez-like games and Skiing games.

In a Guitar hero-like game, for example, a player can press a 5-key control in time with the music. In addition, the background of the game depicts a 3D animation of a rock band, with light effects and camera motion in the style of a music video. According to some embodiments, the game-play can be described by a sequence of timed events taken among the following set {“note on fret 1”, “note on fret 2”, “note on fret 3” . . . }, and continuous game variables updating the camera angle and animation of the background. In a Rez-like game, a player must shoot targets appearing in time with the music. The background of the play-field slowly changes, with different colors corresponding to different sections of the music. According to some embodiments, the game-play can be described by a sequence of timed events taken from the following set {“enemy type 1 appearing on left”, “enemy type 1 appearing on right”, “enemy type 2 appearing on left”, “enemy type 2 appearing on right”, etc.}, and a continuous game variable updating the background color. In a Skiing game, a player must slalom through gates located at the left, middle and right of the track. The slope of the track, and the snow quality can vary. According to some embodiments, the game-play can be described by a sequence of timed events from the following set {“gate at the right of the track”, “gate at the center of the track”, “gate at the left of the track”}, and two continuous game variables updating the slope of the track and the properties of the snow.

For the purposes of this disclosure, an event is a specific, discrete change in the state of the game to which a player must react. By way of a non-limiting example, the apparition of an obstacle or enemy the player must avoid or destroy.

For the purposes of this disclosure, a continuous game variable is a continuous signal, the sample rate of which is the frame rate of the game, controlling the visual appearance (e.g., color, geometry) of a game element.

For purposes of this disclosure, the term “level design” refers to a process by which an audio file is analyzed to generate sequences of timed events controlling the core game-play (i.e., the course the player will have to clear), and sequences of continuous game variables controlling the change in appearance of the game elements over time (e.g., the visual aspect of the course). The present disclosure discusses a system, which will be referred to herein as an automatic level design (ALD) system, for automating the level design procedure.

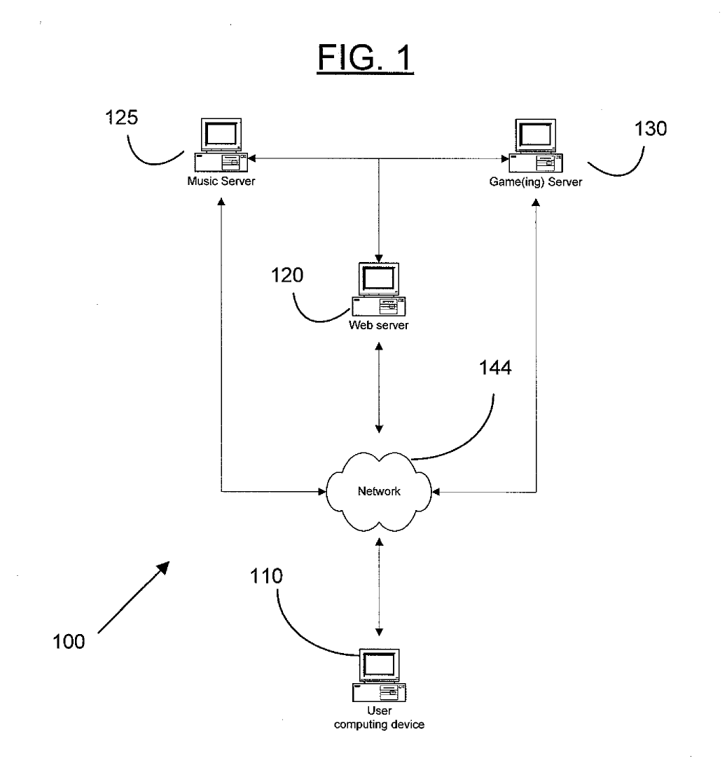

Certain embodiments will now be described in greater detail with reference to the figures. In general, with reference to FIG. 1, a system 100 in accordance with an embodiment for developing elements of a video game from an audio signal is shown. The user accesses or plays a game at a user computing device 110. According to some embodiments, the game can be provided by a game server 130. The game server 130 can either provide the game directly to the user computing device over network 144, or via the web server 120, as illustrated. Also, the game may be provided locally at the user computing device 110. According to some embodiments, the game may be provided via a compact disc, via download over the network 144, or any other means known in the art.

The audio signal, which is analyzed by the web server 120 as discussed below, can be provided by the end user (or player) associated with the user computing device 110. The audio signal may also be provided to the web server 120 by a music server 124. As discussed below, after computation by the web server 120 with regard to the audio signal, the relevant data from the computation is communicated by the web server 120 to the user computing device 110 over network 144.

Each of the user computing device 110, web server 120, music server 125 and game server 130 can be communicatively coupled via the network 144, such as the Internet. Although different steps are being performed by the web server 120, music server 125 and the game server 130, it should be noted that any one or more of the steps can be performed by either of the web server 120, music server 125 and the game server 130, or the function can be combined in a single server. In accordance with some embodiments, the game server 130, music server 125 and the web server 120 can be a single server or multiple servers, and can be at a single location or multiple locations. According to some embodiments, the servers listed in system 100 is not an exhaustive depiction of servers. Responsibilities of the servers can include, and are not limited to: storing music files, game levels and analysis data; maintaining the shared state of the game (such as in a multi-player game); processing the stored music files and generating analysis files; performing level design (taking, as input the analysis data and game description) and generating level files; and serving the music files and level files to the user. User computing device 110 includes a program for interfacing with the network 144. Such program, as understood in the art, can be a window or browser, or other similar graphical user interface, for visually displaying the game to the end user (or player) on the display of the user computing device 110.

It is to be understood that the present disclosure may be implemented utilizing any number of computer technologies. For example, although certain embodiments relate to providing access to a created game level via the Internet, the disclosure may be utilized over any computer network, including, for example, a wide area network, local area network or, corporate intranet. Similarly, the user computing device 110 may be any computing device that may be coupled to the network 144, including, for example, personal digital assistants, Web-enabled cellular telephones, devices that dial into the network, mobile computers, personal computers, Internet appliances, wireless communication devices, game consoles and the like. Furthermore, the servers described herein may be of any type, running any software, and the software modules, objects or plug-ins may be written in any suitable programming language.

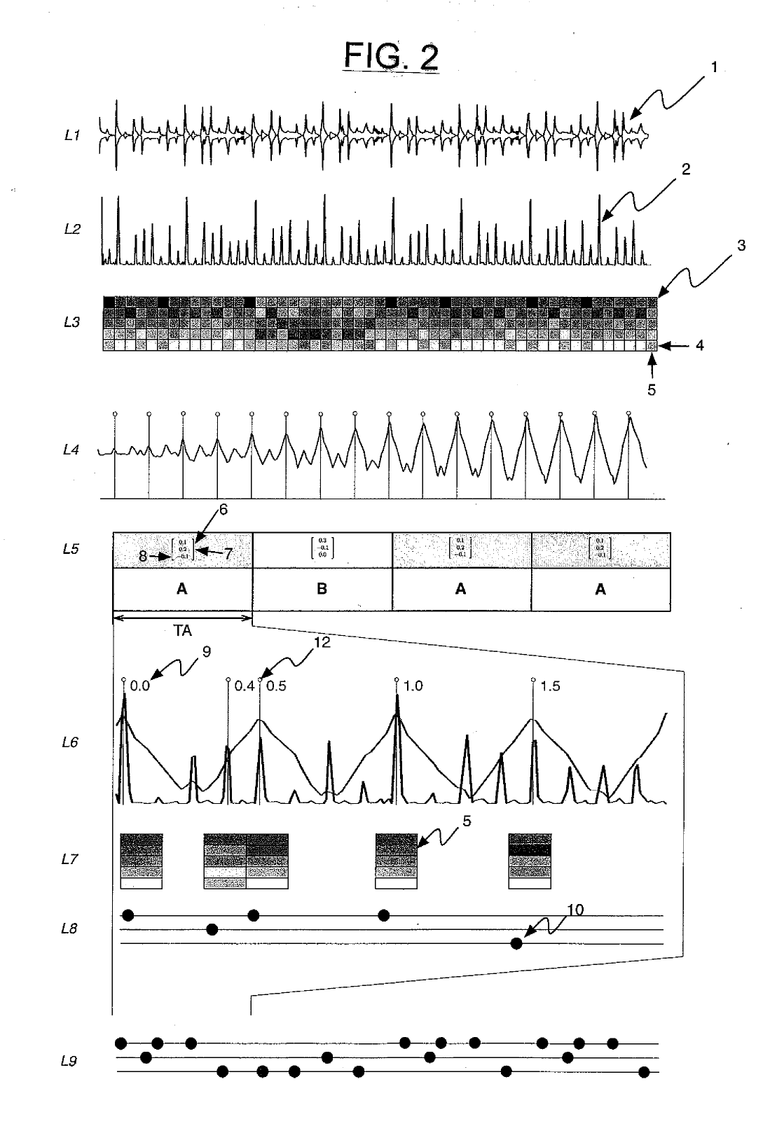

FIG. 2 illustrates a schematic of an audio signal in accordance with an embodiment of the present disclosure. FIG. 2 is broken down into nine superposed lines L1-L9, each line corresponding to a step for transcribing a piece of music into a level of a video game. Each line is a temporal representation, with the time t flowing from an origin 0 at the left of the line towards the right.

The first line L1 represents, in amplitude, an original raw audio signal 1. The original signal 1 is a piece of music chosen from system 100. The music can be provided to the user computing device 110 by player 140 as a piece of background music for the video game which he is getting ready to play. The system 100 of FIG. 1 comprises means, which will be described below for implementing the method according to the disclosure. According to some embodiments, transcribing of the music into a level of the game may further entail an association of the audio data with the background music of the game. To simplify the description, the signal 1 is merely an extract of duration T1, measured from the origin 0, of a piece of background music.

The second line L2 corresponds to a representation of the onsets of notes 2 pinpointed in the signal 1.

The third line L3 is a representation, in the form of a matrix of rows 4 and columns 5 of attributes 3 of the signal 1. Each column corresponds to a short time window, as discussed below. The shading in FIG. 2, line L3 represents values between 0 and 1. For example. the shading may correspond to a 4-bit word. In some embodiments, as shown, the heaviest shaded windows denote values equal to, or nearly equal to 1, and the lightest shaded regions (e.g., the regions completely white or not shaded) correspond to values equal to, or nearly zero. The shadings of the windows represent fractional denominations between a value range from 0 to 1. According to some embodiments, the extraction of the attributes is not necessarily done, and generally not done, in a manner synchronous with the notes 2.

The fourth line L4 is a representation of the beats extracted from the signal 1.

The fifth line L5 is a representation of the signal 1 in the form of blocks A, B, each block corresponding to particular attributes 3. The fifth line L5 illustrates the recurrence of the blocks A, B in the signal 1.

The next three lines L6-L8 are on a different scale to the others, since they illustrate the processing of the first block A from among the blocks A, B. The sixth line L6 illustrates the detection of the salient notes 12 of the block A, from among the onsets 2 of the second line L2. The events in the game, such as but not limited to obstacles or arrival of enemies, must coincide with the most salient musical notes within a block. To this purpose, according to some embodiments, a saliency score is assigned to each note and beat detected in the music of the audio signal. This saliency score is an approximation of the perceptual saliency of the note within the audio signal. The saliency score is computed through standard machine learning techniques (such as, Bayesian classifier, Support vector machines) on a set of variables which include an envelope strength, loudness (measured by a psychoacoustic model), beat strength and timbral coefficients. The P most salient notes (or instants) are selected according to the saliency score. The number P is a product of factors: (1) a measure of the relative rhythmic density of the block, (2) a constant set by the game designer, which is proportional to the target game difficulty, and (3) the block duration. The first factor ensures that rhythmically dense sections of the music contain a plurality of game events, while relatively sparse sections of the music of the audio signal will trigger less game events. The second factor gives the game designer a way of adjusting the difficulty of the game depending on easy/medium/hard levels. The third factor ensures that the game difficulty will be held constant independent of the audio signal's base tempo. For example, beginners might want to play a fast song. Thus, experimented players much be able to play a challenging game even on a slow track. The seventh line L7 represents, in the form of column matrices 5, the attributes 3 assigned to each of the salient notes 12, as determined in the third line L3. The eighth line L8 represents in the form of a span of three lines, events 10, each assigned to one of the salient notes 12.

The ninth line L9 is a representation similar to that of the eighth line L8, but for the complete duration T1 of the signal 1.

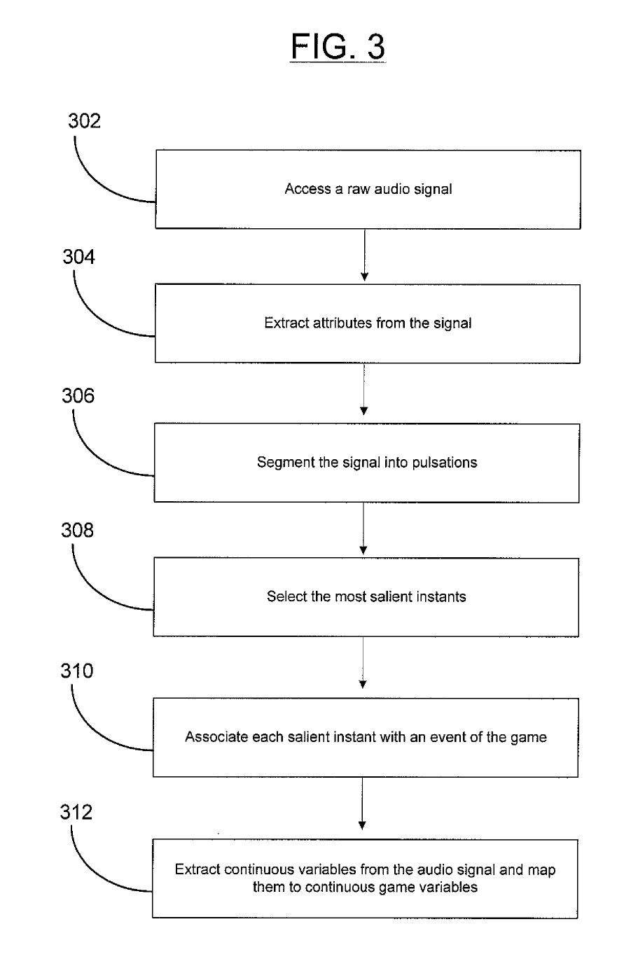

Having discussed the functional transcribing of a piece of music into a level of a video game, its general operation will now be described with reference to FIG. 3. FIG. 3 is a flow diagram of an embodiment of a method for analyzing a raw audio signal, as disclosed in FIG. 2. First a raw audio signal is accessed by a computing device. Step 302, which corresponds to line L1 from FIG. 2. The audio signal can be accessed by a user computing device or by a server device, as disclosed in FIG. 1. Attributes of the audio signal are extracted. Step 304, which corresponds to lines L2 and L3 of FIG. 2. The signal is then extracted into pulsations (or blocks). Step 306. This step corresponds to line L4 of FIG. 2. After the extraction of the signal in Step 306, for each pulsation (or block), the most salient notes are selected. Step 308, which corresponds to line L6 of FIG. 2. The association of the salient instants is based upon a difficulty constraint for the game. The selection includes sorting all of the detected note onsets according to a saliency index, and selecting the P most salient events, where P is made proportional to the target difficulty level. Accordingly, there are two modes of operation for said selection. Either the system runs a batch process on a server, in which all the level files are generated for pre-determined sets of difficulty constraints. For example, “easy”, “medium” or “hard” difficulty levels. These levels are stored in a database, and are subsequently served to the client over the network. The client can only request one of the “preset” difficulty levels. In an alternative embodiment, the system is embedded in the game running on the client. Here, the difficulty constraints are directly controllable by the player. This can include a finer-grained control, for example, a continuum of choices between “easy” to “hard”, or individual controls for a number of events and difficulty, etc. Thus, the generated level data is directly made available to the game. In Step 310, each salient note is associated with an event of the video game. In Step 312, continuous variables from the audio signal are extracted and mapped to continuous game variables of the game.

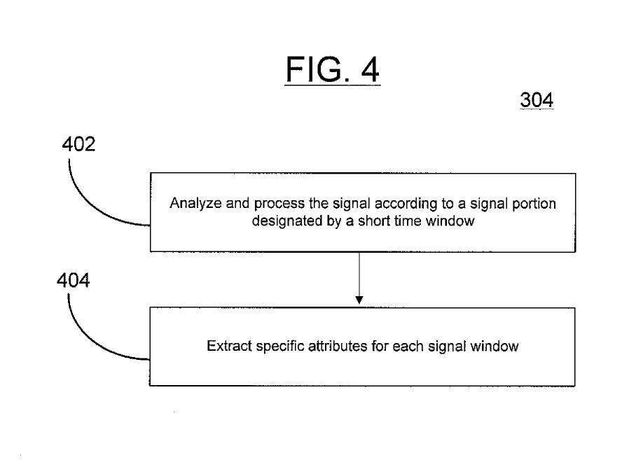

FIG. 4 is a flow diagram of an embodiment for extracting the attributes of the signal, as discussed above in step 304 of FIG. 3. In the FIG. 2, the raw signal 1 is a sampled audio signal and not a score or a sequence of musical events such as might be contained in a MIDI file. Such files are typically encoded in the MP3 format or recorded in the form of non-compressed PCM samples in WAV files. In Step 402, the signal is analyzed and processed according to a signal portion designated by a short time window or frame. Specifically, the signal is broken down into a grid of overlapping frames, characterized by (1) a frame duration and (2) an overlap ratio between frames. By way of a non-limiting example, values can include, but are not limited to, 20 ms for the frame duration, and 50% for the overlap ratio. This analysis and processing ensures that the signal has stable properties and can be considered as stationary over the duration of the short time windows. In Step 404 each signal portion, delimited by a respective frame (or window), we extract: the sound power, or acoustic intensity, as measured according to a psycho-acoustic model; timbre coefficients obtained by dimensional reduction (for example with the aid of a discrete cosine transformation or by a Karhunen-Loeve transformation) of the spectrum on a logarithmic or Mel scale; chroma coefficients obtained by binning into 12 classes, one for each of the twelve tones of the chromatic scale, or by coding, according to twelve classes, the output data from an estimator of multiple fundamental frequencies; spectral attributes, such as, but not limited to, the spectral flatness, the cutoff point, the centre of gravity or the fourth-order moment of the spectrum; the dominant fundamental frequency, estimated for example by an algorithm such as YIN; and a statistical measure of the di-similarity between a first and a second long window centered on the current short window. The statistical measure of di-similarity makes reference to a degree of novelty which is a maximum when the center of the time window coincides with a point of transition between two sections (verse, refrain). The statistical measure of di-similarity may typically be based on statistical measures such as the Kullback-Leibler divergence or the Bhattacharyya distance, or on procedures derived from testing hypotheses known in the art.

Each of the extracted attributes from Step 404 are represented by one of the five rows of the matrix of line L3 from FIG. 2. The set of attributes extracted at an instant T corresponding to a short analysis window is represented by a column vector of the matrix of line L3 from FIG. 2. The attributes listed above represent an instantaneous capture of the perception of the sound; respectively the power, the timbre, the harmony, the color or brightness of the tone, the pitch and the surprise effect for the listener.

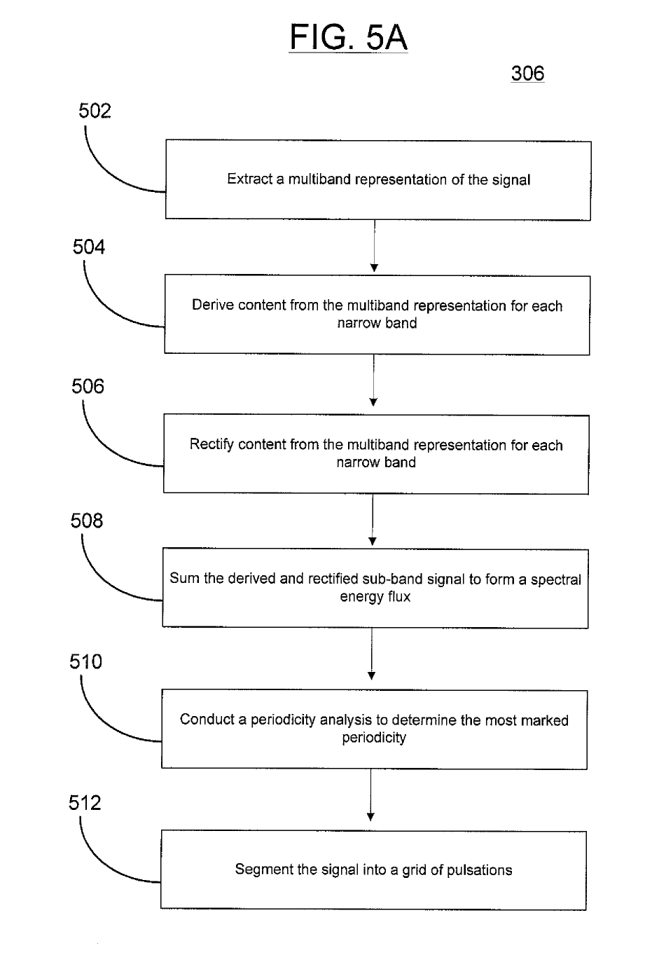

FIG. 5A is a flow diagram of an embodiment for temporal segmentation of the audio signal into pulsations, as discussed above in Step 306 of FIG. 3. For the purposes of segmentation, a function exhibiting sharp amplitude spikes at the start of notes and percussive events is extracted. This function is referred to as the onset detection function. It can be obtained through the sequence of signal processing operations described in FIG. 5A: extracting, in Step 502, a multiband representation of the signal (by means of a Mel scale spectogram, or by decomposition by means of a filter bank), and then deriving, in Step 504, and rectifying in Step 506, the content of each narrow band of the multiband representation of the signal. The sum of the derived and rectified sub-band signals forms a spectral energy flux. Step 508.

In Step 510, a periodicity analysis is then conducted to determine the most marked periodicity. Such an analysis is typically carried out by determining the fundamental frequency of the onset detection function. The periodicity of the onset detection function is used to get an estimate of the tempo. Once the tempo is known, the position of the beats is found by finding the grid of events that are: (1) regularly spaced, with a spacing compatible with the detected tempo; and (2) maximally coincides with the detection function. For example, in accordance with the above discussion, once this periodicity is known, it is now possible, by means of dynamic programming or Viterbi decoding, to identify the grid of regularly spaced pulses that maximally coincide with the percussive and note events in the music.

Music exhibits a hierarchy of periodicities: the bar, the beat, and the tatum which is the finest rhythmic division over which musical events are aligned. According to some embodiments, by adjusting the interval of the periodicity analysis conducted previously, it is possible to specify the level of periodicity that is utilized for the periodicity analysis in Step 510.

With the aim of designing the course of the game, the music is segmented into a grid of pulsations (or quavers). Step 512. Segmentation entails after analyzing the tempo and detecting the time beats, in Step 512, each beat detected is divided into two, the assumption being made that music mainly uses binary divisions.

FIG. 5B is a flow diagram of an embodiment for partitioning of the pulsations from Step 512 into various blocks, each being characteristic of a section of the piece of music. In Step 514, the attributes 3 extracted in the step of line L3 of FIG. 2 are aggregated over a duration corresponding to the duration of a respective pulsation, so that the values obtained each correspond to a box 4, 5 at the intersection of a respective row 4 and column 5 of the matrix of line L3. Each column is formed of a vector, where each term corresponds to the aggregation of a respective attribute over the duration T2 of a pulsation 2. Typically, the aggregation of the attributes may be done through one of the following operations: calculation of mean, maximum or mode. In Step 516, the music can then be represented by a sequence of pulsations, each pulsation being identified by: a position in time, referenced from the origin 0 of the signal (or the track of a CD); and a vector 5 of audio attributes which comprises all or some of the previously listed attributes (timbre, harmony, etc.).

In Step 518, the pulsations are grouped into blocks of N pulsations, where N is the product of the number of pulsations per bar times a parameter specified by the designer of the game, which describes the duration of a phase of the game. The number of pulsations per bar is determined automatically, or more simply, is based on the assumption that the signature is the one most commonly used, i.e., the 4/4 bar. The parameter may be dependent on the level of difficulty chosen. Thus, for example, in an “easy” mode, the game may consist of small repeated blocks, whereas in a “difficult” mode, the game may contain longer blocks which are therefore more difficult to memorize.

In Step 520, the blocks are clustered into “K×d” categories, where K is a parameter determined by the designer of the game and d is the duration of the musical track. The parameter K allows the designer to achieve a compromise between a monotone but easily memorizable level (small value of K) and a ceaselessly changing level which is difficult to memorize (large value of K). The partitioning is performed by vector quantization (VQ) or by agglomerative clustering (AC). The metric used to compare the blocks is the mean or the maximum of the distances, evaluated pairwise, between the pulsations from which the blocks are constructed. The metric used to compare the pulsations may be of a geometrical or statistical nature (Euclidian distance, scalar product, Kullback-Leibler divergence, Mahalanobis distance, Bhattacharyya distance) applied to a subset of the audio attributes, optionally passed through a dimensional reduction operator. The dimensional reduction ensures the robustness of the process to numerous musical genres. For example, a folk song exhibits little variability of the timbre coefficients, always corresponding to a combination of voice and guitar, but strong variations of the chromatic coefficients, corresponding to changes of chord. In contrast, and according to another non-limiting example, a techno track exhibits little variability of chords but strong variability in the textures of timbres. A dimensional reduction of the Karhunen-Loeve transform type allows the system to pinpoint the most changeable aspects of the music.

After Step 522, the music is represented by a sequence of blocks aligned with the pulsations and labeled with a category index (A, B). Step 520. This enables repeated sections of the music to be translated in the game into identical continuous variables and events, as will result from the following steps.

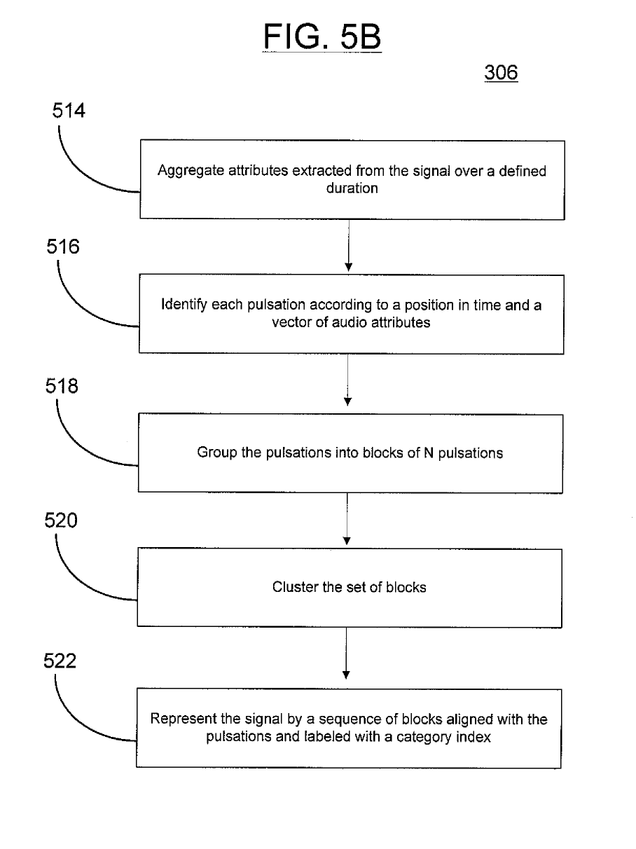

FIG. 6 is a flow diagram discussing the extracting and selecting events from Step 308 of FIG. 3. The process begins with the extraction of the most salient notes, as illustrated by line L6. The events of the game, such as obstacles or the appearance of enemies, must coincide with the most salient musical notes of a block. On line L6, it is the first block, of index A, that is processed. This consists of assigning a salience index 9 to each note and beat detected in the music. Step 602. This salience index is an approximation of the perceptual salience of the note in the signal 1, and this index is obtained by customary automatic learning techniques (Bayesian classifier, vector support machines) on a set of variables which comprises the onset strength, the power, the salience of the rhythmic pulsation, and coefficients describing the timbre.

The P most salient notes (or instants) are selected according to the index. Step 604. The number P is a product: of (1) a measure of the relative rhythmic density of the block, of (2) a constant chosen by the designer and proportional to the targeted difficulty of the game, and to (3) the duration TA of the block. The first factor ensures that sections of the music that are rhythmically dense will contain numerous game events, whereas relatively sparse sections will generate fewer events. The second factor affords the designer of the game a means for adjusting the difficulty of the game according to level; easy, medium or hard. The third factor ensures that the difficulty does not depend on the tempo of the basic track, beginners possibly wishing to play to a song at a fast tempo, and experienced players may wish to play to a slower tune. Certain games require that the events be placed according to a certain “grid” in the music. Thus, the events may be synchronous with the beats, or with the first beat of a bar, or with changes of section. This constraint may be fulfilled by filtering the list of candidate notes.

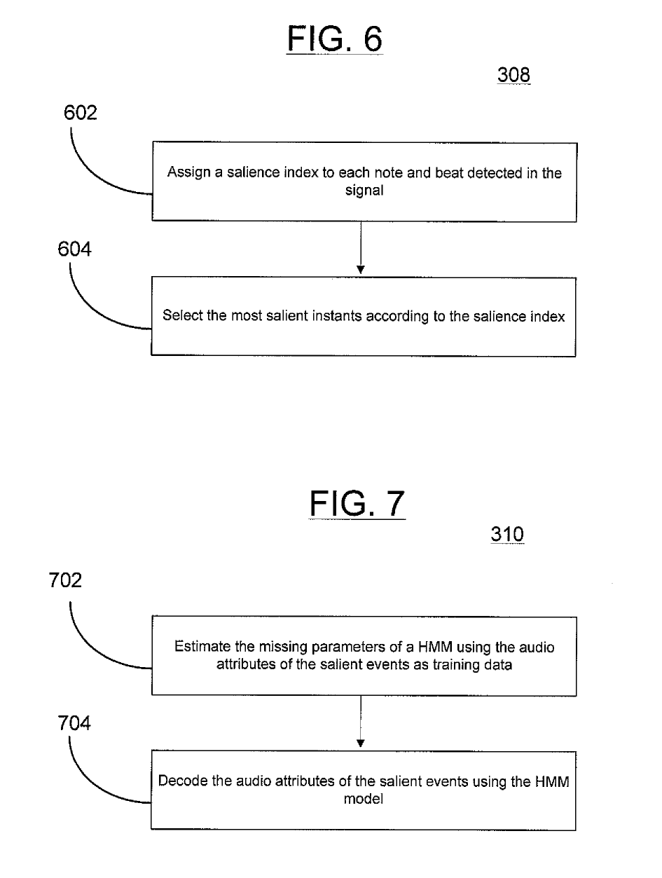

FIG. 7 is a flow diagram of an embodiment for associating salient notes with events 10, as illustrated by line L8 of FIG. 2, and in accordance with Step 310 of FIG. 3. This association may be performed by HMM decoding or based on “patterns”. For sake of explanation only, Step 702 assumes HMM decoding has been performed. In Step 702, the missing parameters of a HMM are estimated using the audio attributes of the salient events as training data.

According to HMM decoding, the association of notes with events of the game must satisfy the following constraints. There must be a correlation between the perception of a note and the event associated with it, so that similar events are always prompted in synchronism with a specific category of sounds. This synchronism may occur at the harmonic level; thus, for example, provision may be made for an event X to occur on the chord of G major and for an event Y to occur on the chord of C major. This synchronism may also occur at the level of the timbre; thus, for example, provision may be made for an event X to occur on a piano chord and an event Y to occur on a brass chord. Also, the event sequence must be able to be played and attain the targeted level of difficulty of the game.

For example, the designer of the game encodes the difficulty of the game in the form of a change-of-state matrix. For example, in a giant slalom skiing game, the “cost” for going from a “gate at the right end of the run” to “a gate at the left end of the run” is very high in an “easy” mode, since the game should not contain such transitions, but is low in a “difficult” mode, since the game should comprise many of these challenges. The adjusting of the transition matrix with the various difficulty levels proposed by the game is the most important manual input required by this method.

In Step 704, the audio attributes of the salient events are decoded using the HMM model estimated in Step 702. The association of the audio attributes 5 with game events is obtained by estimating the missing parameters (density of emission) of the HMM on the basis of the audio attributes 5 and of the transition matrix provided with the game's design rules. The parameters of the model are estimated by a modified Baum-Welch algorithm, and the sequence of game events is obtained by Viterbi decoding of the audio attributes through this model.

The pattern-based approach is another embodiment for associating a game sequence with each block, as discussed in FIG. 7. This procedure presupposes that the designer of the game has created a library of short sequences of game events to which reference will subsequently be made in the guise of “patterns”. Each pattern is assigned a difficulty index, such as it is perceived by the designer, measured objectively as a function of the constraints imposed by the physical engine of the game or estimated according to the player's past performance.

The pattern-based approach consists in selecting, for each block A, B, a pattern from the library. This selection is made by maximizing a compatibility measure which takes into account: the correlation between the temporal position of the events of the pattern and the temporal position of the salient notes in the block, as measured, for example, by a precision/recall index, the correlation between the events of the pattern and the audio attributes, as measured from statistical measures such as Mutual Information, the distance between the sum of the difficulty indices of the whole set of blocks and a targeted difficulty index. The first two terms guarantee that the game events are perceived as synchronous and in tune with the music. The latter term allows the designer of the game to adjust the difficulty of the game. The optimization problem being NP-complete, the traditional field of solution strategies may be deployed, such as genetic algorithms, simulated annealing or a greedy search.

As discussed above in relation to Step 312 of FIG. 3, sequences of raw audio attributes are processed, transformed and combined to yield sequences of values which will be mapped to continuous game variables. The following additive model is used to update, for each setting of the game, the appearance of the elements of the game which are controlled by the music:

Destination (t)=Σ_{source} amount×transformation₁ ( . . . transformationₙ(source(t))) in which the sources are values taken at the instant t by one of the attributes extracted from the audio signal, including the salience of a note or of a beat. The amount is a multiplicative scalar constant. The destinations are controlled continuous game variables. Raw audio attributes are the inputs. They are processed through the above equation to yield a family of signals Destination (t). Each continuous game variable “tracks” the value of one of the destination.

The transformations are taken from among a set of signal conditioning operators, such as: a normalization, which scales the signal so that its dynamic range is the interval [0,1]; a standardization, which scales the signal so that its mean and its standard deviation are respectively 0 and 1; a compression, which reduces the contrast between the highest and the lowest value of a signal by nonlinear transformations; and a Gaussianization, which guarantees that the statistical distribution of the values of the signal is Gaussian.

As discussed above in relation to at least FIGS. 2-7, the steps for designing a game level include, but are not limited to: segmentation of the track into blocks; extraction of the most salient notes; association of the extracted notes with game events; and determination of the continuous game values.

According to some embodiments, a Domain Specific Language (DSL) is used to allow designers to specify the parameters and organization of these various steps. The language may be used to declare, in each game: the parameters of the method of structural segmentation, in particular the number of blocks per minute; the parameters of zero, one or more methods of event extraction, which are defined by the number of events to be extracted per minute on average, the number of target states, and the cost of transition between the states; the declaration of zero, one or more continuous variables, linked to chains of sources and of transformations.

An exemplary descriptive file for the slalom skiing game cited previously is:

```
segmentation {
  block_duration = 8,
  blocks_per_minute = 6
}
// This block describes how the main game events (gates at the left,
// center, and right of the track) are extracted
gates {
//The 20 most salient events per minute are extracted.
@notes (20 per minute){
//The audio attributes are clustered together to obtain 3
//classes of events with the given probabilities of
//transition.
(timbre|chroma)->cluster(
    {‘left’,‘center’,‘right’},
    {{0.8,0.2,0.0}, {0.2,0.6,0.2}, {0, 0.2, 0.8}}
  )
  }
}
//Furthermore, the game provides for bonus mogul zones at
//transition sections
moguls{
@sections { }
}
//The slope of the run is calculated on the basis of the
//power of the music.
//Its value is refreshed at the same rate as the images of
//the game (30 fps).
run_slope{
  @fps(30){
  loudness->normalize( )
  }
}
//Finally, the quality of the snow is calculated on the basis
//of the degree of harmonicity of the audio signal.
snow_quality{
@fps(30){
harmonicity->compress( )->normalize( )
  }
}
```

A software implementation of the method of the disclosure will now be described.

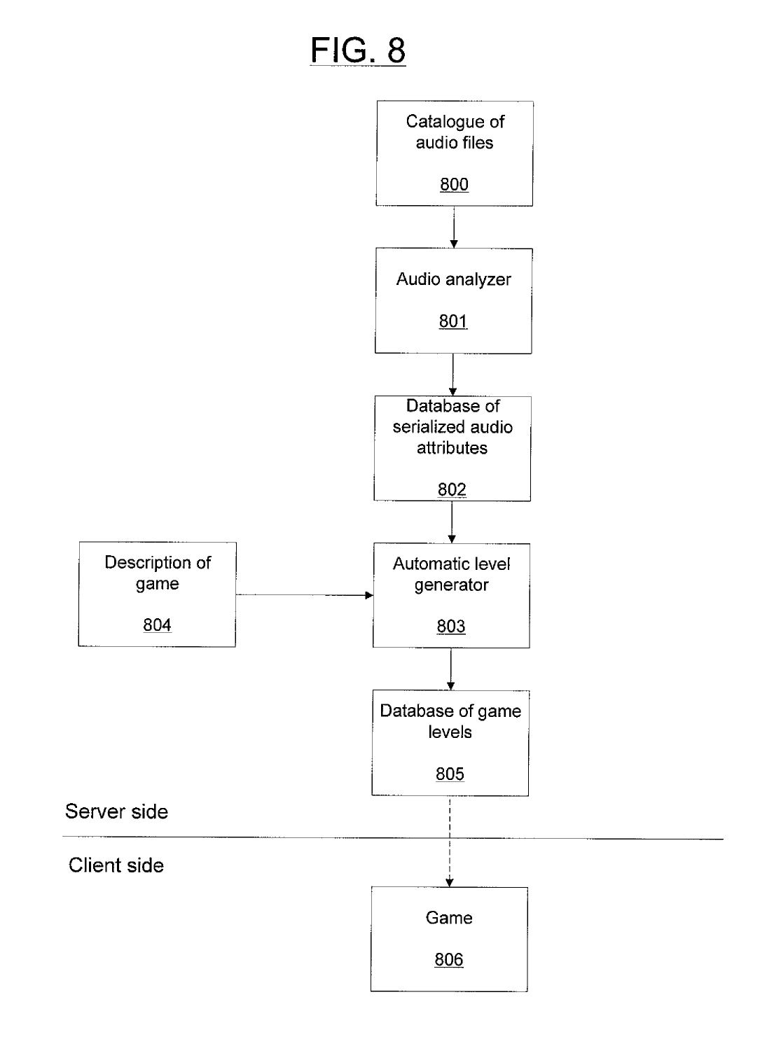

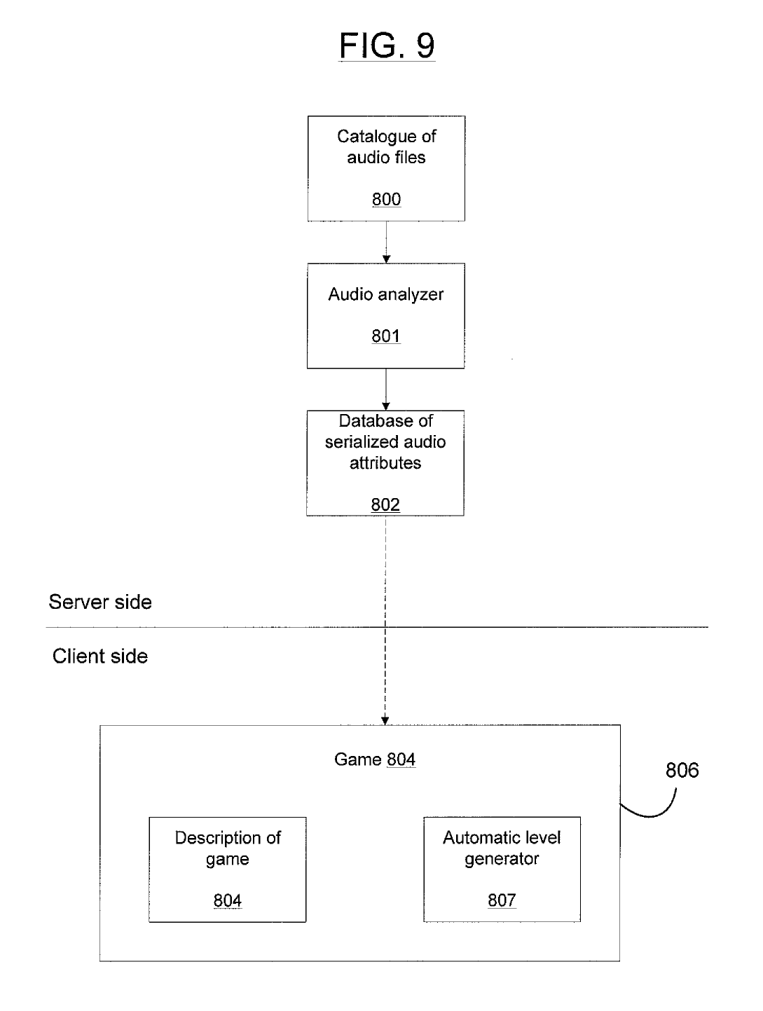

FIGS. 8 and 9 illustrate block diagrams for processing an audio signal in accordance with an embodiment of the present disclosure FIGS. 8 and 9 disclose a software or modular, engine or service level implementation for automatic level design, as discussed herein. The software, modules, engines or services could be hosted by the user computing device 110, and/or the web server 120. In some embodiments, the software could be hosted by either the music server 125 or the game server 130. In connection with the discussion of FIGS. 1-7, the FIGS. 8 and 9 comprise modules, engines and/or services that comprise an audio analysis service 801 which calculates the audio attributes and the segmentation into notes/beats/bars/sections of the audio signal or file. The resulting data structure is serialized in the form of a stream of bytes and written to a database 802. An interpreter module 803 for the game description DSL, operating on the server side, interprets a descriptive file 804 specific to a game and sequences the signal processing or statistical analysis operations required to obtain the final list of events and the continuous variables on the basis of the serialized audio analysis data. The result is written to a text file in the XML or JSON format, written to a database 805, and delivered to the game 806 operating on the client side (player). A client side interpreter module 807, providing a different operating mode, the analysis file 802 being stored on the server side, and transferred to the client at the start of the game.

The availability of both a “server-side” operating mode, illustrated in FIG. 8, and of a “client-side” mode, illustrated in FIG. 9, guarantees that various compromises between use of bandwidth and of processor resources on the client side may be achieved. According to some embodiments, the generation of the level can operate on the client side. According to some embodiments, the generation is done on the server, stored on a database, and the client access the information from the database.

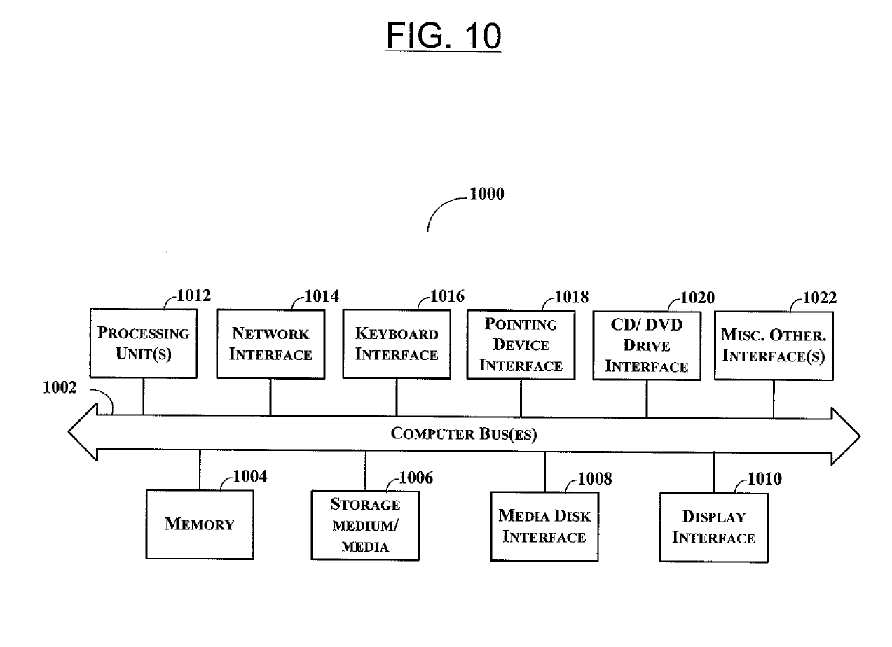

FIG. 10 is a block diagram illustrating an internal architecture of an example of a computing device, such as server computers 120, 125 and 130 and/or user computing device 110, in accordance with one or more embodiments of the present disclosure. A computing device as referred to herein refers to any device with a processor capable of executing logic or coded instructions, and could be, as understood in context, a server, personal computer, set top box, smart phone, pad computer or media device, to name a few such devices.

As shown in the example of FIG. 10, internal architecture 1000 includes one or more processing units (also referred to herein as CPUs) 1012, which interface with at least one computer bus 1002. Also interfacing with computer bus 1002 are persistent storage medium/media 1006, network interface 1014, memory 1004, e.g., random access memory (RAM), run-time transient memory, read only memory (ROM), etc., media disk drive interface 1008 as an interface for a drive that can read and/or write to media including removable media such as floppy, CD ROM, DVD, etc. media, display interface 1010 as interface for a monitor or other display device, keyboard interface 1016 as interface for a keyboard, pointing device interface 1018 as an interface for a mouse or other pointing device, and miscellaneous other interfaces not shown individually, such as parallel and serial port interfaces, a universal serial bus (USB) interface, and the like.

Memory 1004 interfaces with computer bus 1002 so as to provide information stored in memory 1004 to CPU 1012 during execution of software programs such as an operating system, application programs, device drivers, and software modules that comprise program code, and/or computer executable process steps, incorporating functionality described herein, e.g., one or more of process flows described herein. CPU 1012 first loads computer executable process steps from storage, e.g., memory 1004, storage medium/media 1006, removable media drive, and/or other storage device. CPU 1012 can then execute the stored process steps in order to execute the loaded computer-executable process steps. Stored data, e.g., data stored by a storage device, can be accessed by CPU 1012 during the execution of computer-executable process steps.

Persistent storage medium/media 1006 is a computer readable storage medium(s) that can be used to store software and data, e.g., an operating system and one or more application programs. Persistent storage medium/media 1006 can also be used to store device drivers, such as one or more of a digital camera driver, monitor driver, printer driver, scanner driver, or other device drivers, web pages, content files, playlists and other files. Persistent storage medium/media 1006 can further include program modules and data files used to implement one or more embodiments of the present disclosure.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and applications software which support the services provided by the server.

For the purposes of this disclosure, a computer readable medium stores computer data, which data can include computer program code that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure the term “end user”, “user” or “player” should be understood to refer to a consumer of data supplied by a data provider. By way of example, and not limitation, the term “user” can refer to a person who receives data provided by the data provider over the Internet in a browser session, or can refer to an automated software application which receives the data and stores or processes the data.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium. Modules may be integral to one or more servers, or be loaded and executed by one or more servers. One or more modules may be grouped into an engine or an application.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client or server or both.

Thus, instead of a part of the method being implemented by a server remote from the player, provision may be made for a system composed of a games console, of an input for music, of an input for introducing the game into the console, the console being provided so as to implement the whole of the method. The input for the music may be a USB port or a digital disk reader.

According to some embodiments, rather than the method according to the disclosure being implemented by an end user of a game, that is to say a player, it may be used at the game development stage, to reduce or replace the irksome operations of transcribing a piece of music into a synchronous level.

In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

While the system and method have been described in terms of one or more embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims

1. A method comprising:
analyzing, via a computing device, an audio signal;
extracting, via the computing device, audio attributes from said signal;
segmenting, via the computing device, said signal into pulsations based on the extracted audio attributes;
selecting, via the computing device, salient instants of said signal based on a salience index for each extracted attribute; and
associating, via the computing device, each salient instant with an event of a game.

2. The method according to claim 1, further comprising:
extracting continuous variables from said signal;
mapping said extracted variables from said signal to continuous game variables of said game.

3. The method according to claim 1, wherein the association of the events is based on a difficulty constraint for the game.

4. The method according to claim 1, wherein the audio attributes comprise at least one attribute from among, at a given instant:
sound loudness measured according to a psycho-acoustic model;
timbre coefficients;
chroma coefficients;
spectral attributes;
dominant fundamental frequency; and
temporal measurements of di-similarity with another instant.

5. The method according to claim 1, wherein after having segmented the signal into pulsations, said pulsations are grouped into blocks of pulsations, the blocks being inter-compared and then clustered in such a way that repeated sections of music correspond to identical continuous variables or events.

6. The method according to claim 1, wherein the events and the salient instants are associated by HMM decoding.

7. The method according to claim 1, wherein the events and the salient instants are associated by patterns by matching a sequence of audio attributes with a corresponding library of predefined patterns.

8. A computer-readable storage medium tangibly encoded with computer-executable instructions, that when executed by at least one processor of a computing device, perform a method comprising:
analyzing an audio signal;
extracting audio attributes from said signal;
segmenting said signal into pulsations based on the extracted audio attributes;
selecting, via the computing device, salient instants of said signal based on a salience index for each extracted attribute; and
associating each salient instant with an event of a game.

9. A system comprising:
a remote server, wherein the remote server performs steps comprising:
analyzing an audio signal;
extracting audio characteristics from said signal;
segmenting said signal into pulsations based on the extracted audio attributes;
selecting, via the computing device, salient instants of said signal based on a salience index for each extracted attribute; and
associating each salient instant with an event of a game.

10. The system according to claim 9, wherein the remote server comprises an audio analyzer for determining the audio characteristics and storage means for said characteristics.

11. The system according to claim 10, wherein the remote server further comprises an automatic level generator for determining a game level of the game on the basis of data descriptive of said game and means for storing said level.

12. The system according to claim 10, wherein the remote server communicates with the game, wherein the remote server receives a determination of a level of the game from said game being rendered on a client computing device, wherein said determination is performed remotely by an automatic level generator of said client computing device, said determination being based on data descriptive of said game and data transmitted by the server.
